(19) United States
(12) Patent Application Publication
(10) Pub. No.: US 2026/0296021 A1
(43) Pub. Date: Oct. 1, 2026

(54) ANTI-WETTING COATING FOR PRINTHEAD CAP SEALS

(71) Applicant: Xerox Corporation, Norwalk, CT (US)

(72) Inventors: Nicholas David Stucchi, Rochester, NY (US); Varun Sambhy, Pittsford, NY (US); Douglas A. Gutberlet, Ontario, NY (US); Santokh Badesha, Pittsford, NY (US); Richard Kalb, Rochester, NY (US)

(21) Appl. No.: 19/091,577

(22) Filed: Mar. 26, 2025

(51) Int. Cl. B41J 2/165; C09D 5/00; C09D 171/02

(52) U.S. Cl. CPC B41J 2/16508; C09D 5/00; C09D 171/02

(57) ABSTRACT

Systems and method for removing water from printhead cap assembly are disclosed. The disclosed systems and method utilize water-repellent, anti-wetting fluid coated on printhead cap seal member or gasket to prevent aggregation of water droplets or residual ink fluids and passively remove them from the printhead cap seal member thus preventing cross-contamination of printhead nozzles thus improving print quality and the life of the printer.

### BACKGROUND

In inkjet printers, the printheads must be properly managed to avoid buildup of dry ink and other contaminants on the printhead nozzles. Current printhead management methods on various inkjet-based printers rely on a cleaning process in which water or water-based cleaning fluid is dripped onto wiping blades that wipe the surface of the jets or nozzles. The residual and resulting fluid, which comprises water or cleaning solution with removed ink and dirt particulates, falls into a waste tray through a cap assembly. If the printhead is not properly cleaned and maintained, dried ink and dirt particulates may form bubbles within the printhead, and/or block the jets or nozzles. This may severely affect the print quality, or worse, cause irreparable damage to the printer.

Therefore, to minimize the ink buildup at the nozzles and prevent dirt buildup on the active surface (i.e., surface where nozzles are located) of the printhead, the cap assembly also provides a docking means for the printhead during standby or long periods of inactivity. The cap assembly typically includes a cap seal member that engages and forms a seal or gasket with the active surface of the printhead in a docked configuration. Accordingly, as the vertical or significantly vertical configuration of the printhead and the cap assembly requires water droplets or drips to fall from the active surface of the printhead into the cap assembly, the cap seal member may be produced from inherently water-repelling, i.e., hydrophobic materials such as silicone to promote the shedding of liquid that may fall on them. However, despite the inherent hydrophobic nature of silicone seals, water droplets have been found to adhere to multiple locations on the cap seal member and not flow into the waste tray.

The presence of water droplets on the cap seal member of the cap assembly poses a major issue to print quality, as the droplets can be transferred from the cap assembly to the printhead when engaging and disengaging from the cap seal member. In this case, depending on the size and location of the droplets, printhead jets or nozzles may be temporarily disabled, or worse, the printhead assembly, which houses the printhead, may be permanently damaged. Hence, any method that can reduce or eliminate water or ink droplets from adhering to the cap assembly is highly desirable to maintain the print quality and lifecycle of the printer.

While mechanical approaches such as using a brush to clean the water off the cap seal member or a pad to absorb residual fluids have been previously utilized, they are not viable long-term solutions as brushes and pads also need to be maintained, replenished frequently, and may leave behind microfibers that may infiltrate and clog the jets or nozzles. Furthermore, chemical approaches such as utilizing different cleaning fluid formulations may pose additional problems. Additional chemicals in the cleaning fluid may react with numerous components in the ink, which may lead to degradation of print quality and damage to the printhead assembly. Thus, a passive approach to reduce or eliminate water from the cap assembly without introducing additional mechanical components or chemicals is needed.

This document describes methods and systems that address some or all of the problems described above.

### SUMMARY

In one aspect, the disclosed technology relates to a printhead cap assembly, comprising: a housing configured to receive a printhead, the housing comprising sidewalls, a bottom wall, and a top aperture forming a tray; and a cap seal member disposed on edges around the top aperture, wherein: the cap seal member comprises a first surface configured to engage with and form a seal around the surface of the printhead when the printhead is docked in the housing; the first surface is coated with an anti-wetting solution, and in an undocked configuration, the cap seal member is configured to receive residual fluid from the printhead and direct the residual fluid into the tray. In some embodiments, the first surface is sloped inwards towards the tray at an angle from about 45° to about 75°. In some embodiments, the coated first surface comprises a water contact angle from about 90° to about 120° or a water sliding angle from about 10° to about 20°.

In some embodiments, the anti-wetting solution comprises: a solvent; and an anti-wetting chemical; wherein the anti-wetting chemical comprises polydimethyl siloxane silicone fluid, perfluoropolyethers, or a combination thereof. In some embodiments, the solvent comprises an alcohol, ketone, acetates, hydrocarbon, fluorinated solvent, or a combination thereof. In some embodiments, the solvent is a fluorinated solvent and comprises chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof. In some embodiments, the anti-wetting chemical is present in the anti-wetting solution in an amount ranging from about 1 wt % to about 25 wt %, based on the total weight of the anti-wetting solution. In some embodiments, the anti-wetting solution is coated on the first surface in an amount from about 0.05 ml/cm² to about 0.5 ml/cm². In some embodiments, the coated first surface maintains anti-wetting properties for at least about 4 weeks.

In another aspect, the disclosed technology relates to an ink printer comprising the printhead cap assembly.

In another aspect, the disclosed technology relates to a method for coating a printhead cap seal member with an anti-wetting coating, the method comprising: preparing an anti-wetting coating solution comprising a solvent and an anti-wetting chemical; coating the printhead cap seal member with the anti-wetting coating solution to produce a coated printhead cap seal member; and drying the coated printhead cap seal member, wherein the solvent comprises an alcohol, ketone, acetates, hydrocarbon, fluorinated solvent, or a combination thereof, and wherein the anti-wetting chemical comprises a polydimethyl siloxane silicone fluid, perfluoropolyethers, or a combination thereof.

In some embodiments, the solvent is a fluorinated solvent and comprises chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof. In some embodiments, preparing the anti-wetting coating solution comprises adding the anti-wetting chemical in an amount ranging from about 1 wt % to about 25 wt %, based on the total weight of the anti-wetting coating solution. In some embodiments, coating the printhead cap seal member with the anti-wetting coating solution provides surface of the printhead cap seal member with a water contact angle from about 90° to about 120° or a water sliding angle from about 10° to about 20°. In some embodiments, coating the printhead cap seal member with the anti-wetting coating solution comprises depositing the anti-wetting coating solution onto a transfer medium, and using the transfer medium to apply the anti-wetting coating solution to the printhead cap seal member. In Some embodiments, the transfer medium comprises a brush, rag, or foam.

In some embodiments, coating the printhead cap seal member with the anti-wetting coating solution comprises spraying the anti-wetting coating solution on the printhead cap seal member or submerging the printhead cap seal member in the anti-wetting coating solution. In some embodiments, coating the printhead cap seal member comprises coating from about 0.05 ml/cm² to about 0.5 ml/cm² of the anti-wetting coating solution to the printhead cap seal member. In some embodiments, drying the coated printhead cap seal member comprises air drying the coated printhead cap seal member from about 1 minute to about 15 minutes. In some embodiments, the method further comprises recoating the printhead cap seal member with the anti-wetting coating solution after a threshold period of time.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a view of a printhead assembly and cap assembly in a docked configuration in accordance with the present disclosure.

FIG. 2 is a view of a printhead assembly and a wiping blade in accordance with the present disclosure.

FIG. 3 is a view of a cap assembly in accordance with the present disclosure.

FIG. 4 is another view of a cap assembly in accordance with the present disclosure.

FIG. 5 is a schematic describing a water contact angle measurement of a liquid droplet.

FIG. 6 is a schematic describing a water sliding angle measurement of a liquid droplet.

FIG. 7 is a flow chart describing a method of applying anti-wetting coating on a printhead cap seal member of the present disclosure.

FIG. 8A is a view of a printhead cap seal member with an uncoated section and anti-wetting solution coated section at initial water droplet application.

FIG. 8B is a view of a printhead cap seal member with an uncoated section and anti-wetting solution coated section 2 seconds after the water droplet application.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another, and is not intended to require a sequential order unless specifically stated. The term “about” or “approximately,” when used in connection with a numeric value, is intended to include values that are close to, but not exactly, the number. For example, in some embodiments, the term “about” or “approximately” may include values that are within +/−10 percent of the value.

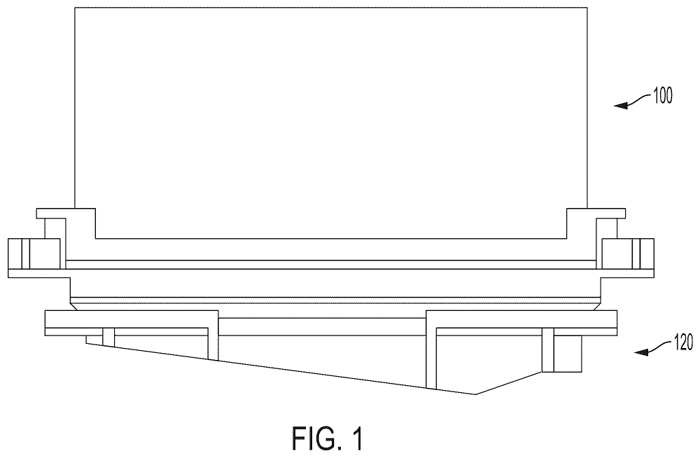

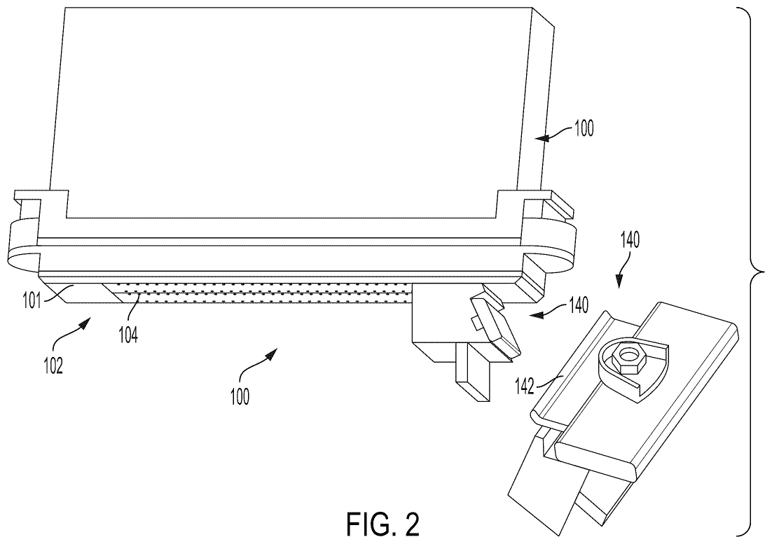

The present disclosure includes a process for applying an anti-wetting coating on the printhead cap assembly for the removal of water or other residual fluids (ink, cleaning fluid, ink particulate solution or suspension) at the printhead assembly-cap assembly interface. As used in this document, an “anti-wetting coating” refers to a coating that, when applied to a surface, will reduce or eliminate the adhesive and cohesive forces that enable water, and optionally other liquids, to spreading out on and maintain contact with the surface. As used throughout this document, an anti-wetting coating also may be referred to as “water-repelling” or “hydrophobic” coating. Now referring to FIG. 1, a schematic view of a printhead assembly 100 and a cap assembly 120 is shown. As seen in FIGS. 1 and 2, when the printer is on a standby phase or inactive for a long period of time, printhead assembly 100, which is stored in a housing and contains liquid ink, is docked to cap assembly 120 (as seen in FIG. 1) to prevent one or more nozzle(s) 104 positioned on printhead faceplate 101, which is located at bottom surface 102 of printhead assembly 100 (as seen in FIG. 2), from being exposed to the environment and prevent contamination from ambient dust particles or high humidity.

While the docking mechanism provides protection from the environment and prevents a significant portion of dust and micro-particulates from being aggregated on nozzle(s) 104, inherent moisture in the printer environment in combination with inactivity results in the accumulation of dried ink at nozzle 104, which can affect the print quality. Furthermore, accumulation of dried ink may partially or fully block or clog nozzle 104, reducing the pressure of the inkjet printing as well as forming air bubbles in the ink reservoir within the printhead, which may irreversibly damage the printhead assembly and require replacement.

Accordingly, printhead management on current state-of-the-art ink printers provides a periodic purge and clean cycle at the nozzle, in order to maintain high-quality printing and service the printhead. In the purge cycle, some of the ink that is near nozzle 104 is ejected from the nozzle via high-pressure. The purging process allows for the dried and accumulated ink at or near nozzle 104 to be fully or partially ejected and removed and allows for fresh ink that is unexposed to the environment to be positioned at nozzle 104. After purging, water or cleaning fluid is sprayed onto wiping blade 142 of the wiping assembly 140 as seen in FIG. 2. In some embodiments, wiping blade 142 may comprise a hydrophobic material such as silicone. In some embodiments, after wiping blade 142 is sprayed with water or cleaning fluid, wiping assembly 140 moves from one end of bottom surface 102 to the other end, wiping off any excess or residual ink that remains on bottom surface 102 of printhead assembly 100. In some embodiments, this wiping step may be repeated more than once to fully remove the unwanted ink build-up at nozzle 104.

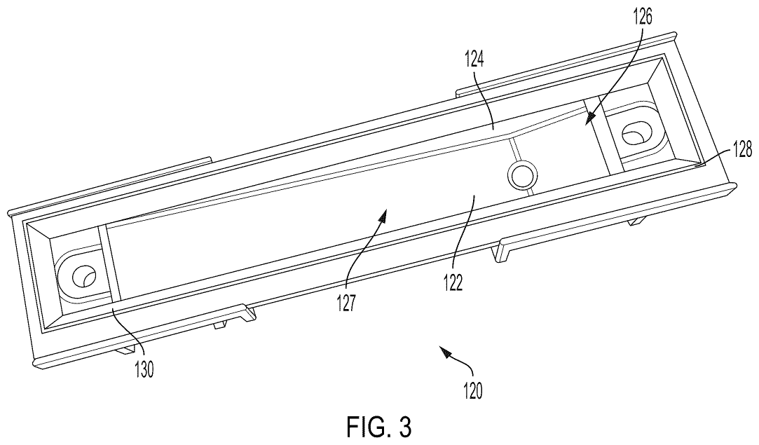

Now referring to FIG. 3, a perspective view of cap assembly 120 is shown and described herein. As seen in FIG. 3, cap assembly 120 may comprise a bottom wall 122, sidewalls 124, and a top opening or a top aperture 126 forming a tray 127 configured to engage with bottom surface 102 of printhead assembly 100 and receive a printhead assembly 100. In some embodiments, as seen in FIG. 3, bottom wall 122 may be at an incline relative to sidewalls 124, to provide a sliding surface for any liquid to slide down and aggregate at the lowest portion, i.e., a trough, of the tray. In some embodiments, cap assembly 120 may comprise a printhead cap seal member 128 that serves as a gasket around the edges of top aperture 126 that interfaces with bottom surface 102 of printhead assembly 100 to provide an airtight seal with the bottom surface 102 when printhead assembly 100 is docked with cap assembly 120.

In some embodiments, as the wiping step is achieved at bottom surface 102, any residual water or ink particles/droplets on wiping blade 142 or printhead assembly 100 are gravitationally directed to tray 127. In some embodiments, printhead cap seal member 128 may comprise sloped surface 130, i.e., “ramp,” sloped inwards that provides gravitational movement or sliding of excess or residual water from printhead cap seal member 128 into tray 127 when water droplets come in contact with sloped surface 130 of printhead cap seal member 128. In some embodiments, sloped surface 130 of printhead cap seal member 128 may be at an angle from about 45° to about 75°, about 45° to about 50°, about 50° to about 55°, about 55° to about 60°, about 60° to about 65°, about 65° to about 70°, or about 70° to about 75°, from a plane extending from edges of top aperture 126.

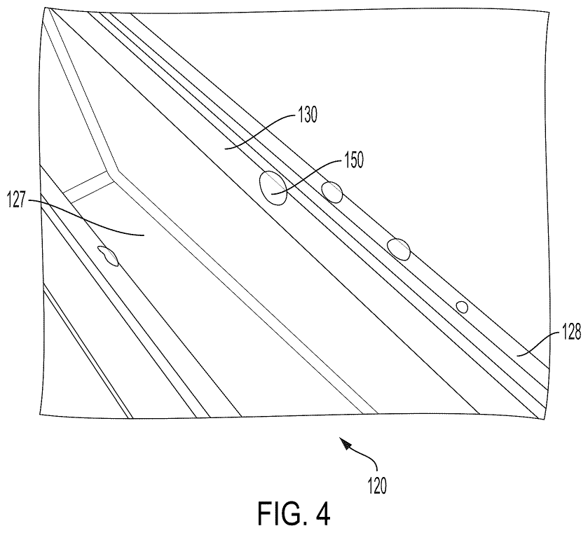

In some embodiments, printhead cap seal member 128 may comprise a hydrophobic material such as silicone. As seen in FIG. 4, in this configuration, the combination of hydrophobic material and sloped surface 130 of printhead cap seal member 128 facilitate the shedding of water droplet 150 or other liquid droplets that may fall on sloped surface 130 of printhead cap seal member 128. However, despite the inherent hydrophobic nature of printhead cap seal member 128 and the sloped surface 130, water droplets have been found to adhere to multiple locations on printhead cap seal member 128 due to the highly cohesive and adhesive properties of water.

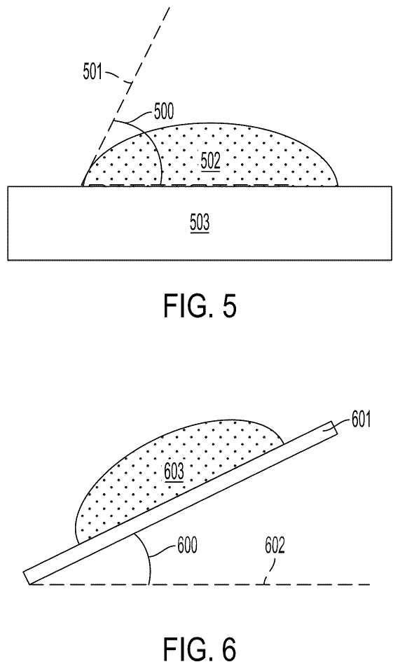

For instance, a conventional, unmodified silicone cap seal member exhibits a water contact angle from about 80° to about 100°. As used herein and illustrated in FIG. 5, the term “water contact angle” refers to the angle 500 formed between the tangent 501 of water droplet 502 and surface 503 at the point of contact. With respect to the hydrophobicity of a droplet, a low contact angle, typically less than about 40° means the water spreads out at the surface 503, and the surface is considered hydrophilic. Conversely, a high contact angle, typically greater than 70° means the water tends to “bead up,” forming a droplet, and the surface is considered hydrophobic.

Additionally, a conventional, the same unmodified silicone cap seal member exhibits a water sliding angle from about 75° to about 90°. As used herein and illustrated in FIG. 6, the term “water sliding angle” refers to a minimum angle 600, also referred to as a “tilt angle” formed between an inclined material surface 601 and a flat plane 602, at which a water droplet 603 begins to slide off a tilted surface due to gravity. Accordingly, a low sliding angle, typically less than 20° indicates that the surface has a low adhesion to water droplets and slides off the water easily. Conversely, a high sliding angle, typically greater than 40° means the surface has a high adhesion to water, causing the droplets to stick or resist movement. Accordingly, while conventional cap assembly provides a hydrophobic surface, i.e., silicone, that provides a suitable water contact angle to alleviate bead formation of water or liquid droplets on the surface, a comparatively higher water sliding angle of the silicone surface may still allow water droplet(s) 150 to adhere and aggregate on multiple locations along sloped surface 130 of printhead cap seal member 128 (as seen in FIG. 4).

Therefore, an aspect of the present disclosure provides a method of preparing and applying anti-wetting coating onto printhead cap seal member of the cap assembly, to increase the water contact angle (to prevent the “spreading” of water droplets on the surface and promote) and reduce the water sliding angle (prevent adhesion of droplets on the surface) to passively and gravitationally remove water from the printhead cap seal member without any additional external mechanical components or chemicals in the water of the cleaning fluid.

In some embodiments, the anti-wetting coating may provide a coated surface with a water contact angle from about 90° to about 120°, about 90° to about 100°, about 100° to about 110° or about 110° to about 120°. In some embodiments, the anti-wetting coating may provide a coated surface with a water sliding angle from about 5° to about 20°, about 5° to about 10°, about 10° to about 15°, or about 15° to about 20°. In some embodiments, the anti-wetting coating solution may comprise a solvent and an anti-wetting chemical. In some embodiments, the solvent may comprise an alcohol, ketone, acetates, hydrocarbon, mixture thereof, or fluorinated solvent.

In some embodiments, the solvent may be a fluorinated solvent and may comprise chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof In some embodiments the solvent may comprise an alcohol, ketone, acetates, hydrocarbons, such as ethyl alcohol, propyl alcohol, isopropanol, acetone, methyl ethyl ketone, ethyl acetate, butyl acetate, hexane, octane, decane, tetrahydrofuran, or mixtures thereof. In some embodiments, alcohols that may be used as a solvent may comprise but are not limited to methanol, ethanol, propanol, isopropanol, or a combination thereof. In some embodiments, the fluorinated solvent may be an ethoxy-nanoafluorobutane (C₄F₉OC₂H₅) such as that marketed under the brand name Novec™ 7200 (obtained from 3M). In some embodiments, the fluorinated solvent may be an ethyl nonafluorosbutyl ether (C₅H₅F₅O) such as that marketed under the brand name BestSolv™ 7200 (obtained from Bestsolv).

In some embodiments, the anti-wetting chemical may comprise polydimethyl siloxane silicone fluid, perfluoropolyethers, or a combination thereof. In some embodiments, the anti-wetting chemical is a dialcohol terminated, exthoxylated perfluoropolyether such as that marketed under the brand name Fluorolink® E10-H. In some embodiments, the anti-wetting chemical may be present in the anti-wetting coating solution in an amount ranging from about 1 wt % to about 25 wt %, about 1 wt % to about 5 wt %, about 5 wt % to about 10 wt %, about 10 wt % to about 15 wt %, about 15 wt % to about 20 wt %, or about 20 wt % to about 25 wt %, based on the total weight of the anti-wetting coating solution.

In some embodiments, the anti-wetting coating may be applied to printhead cap seal member 128 in an amount sufficient to prevent adhesion and spreading of water on sloped surface 130. In some embodiments, the anti-wetting coating may be applied to printhead cap seal member 128 in an amount ranging from about 0.05 ml/cm² to about 0.5 ml/cm², about 0.05 ml/cm² to about 0.1 ml/cm², about 0.1 ml/cm² to about 0.2 ml/cm², about 0.2 ml/cm² to about 0.3 ml/cm², about 0.3 ml/cm² to about 0.4 ml/cm², or about 0.4 ml/cm² to about 0.5 ml/cm², to provide a thin, uniform layer of the anti-wetting coating. In some embodiments, the anti-wetting coating on printhead cap seal member 128 may maintain anti-wetting properties for a threshold period of time.

In some embodiments, a threshold period may be a time period for the coated printhead cap seal member to exhibit a decrease in anti-wetting properties due to degradation of the anti-wetting coating. The threshold period of time may vary depending on the frequency of printer use, the number of purge and clean cycles, or the concentration or formulation of the anti-wetting coating solution utilized. In some embodiments, the anti-wetting coating may maintain anti-wetting properties for about 1 week to about 4 weeks, about 1 week to about 2 weeks, about 2 weeks to about 3 weeks, about 3 weeks to about 4 weeks, or at least about 4 weeks, at least about 3 weeks, at least about 2 weeks, or at least about 1 week.

In some embodiments, the anti-wetting coating may optionally be applied to printhead faceplate 101 (as shown in FIG. 2) to prevent any adhesion or aggregation of water, ink droplets, or residual cleaning fluid on or near nozzle 104 of printhead assembly 100.

In some embodiments, the cap assembly of the present disclosure may be incorporated in various ink printers, e.g., an inkjet printer, and may be easily replaceable. The specific design of the cap assembly may be modulated based on the dimensions of the printhead and/or the type of ink, i.e., hydrophobicity of the ink, used in a specific printer model.

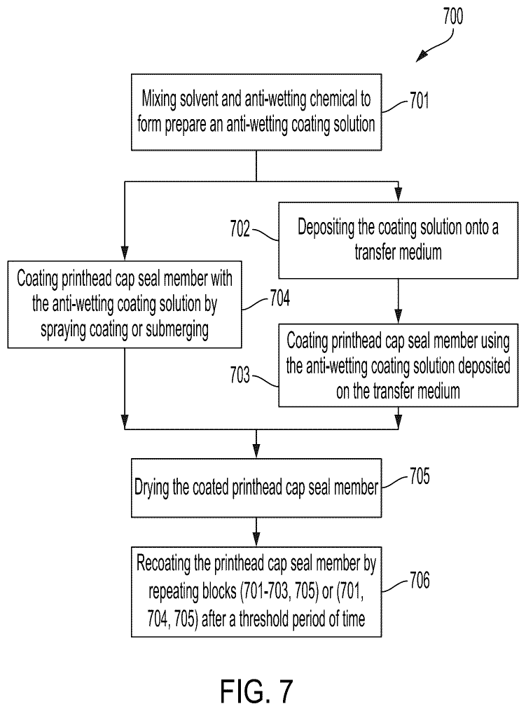

The present disclosure also relates to a method of coating a printhead cap seal member with an anti-wetting coating disclosed above. Now referring to FIG. 7, a flow chart illustrating an exemplary process 700 for coating a printhead cap seal member of the cap assembly with an anti-wetting coating solution is shown. Process 700 begins with block 701, where an anti-wetting coating solution is prepared by mixing anti-wetting chemical in a solvent. In some embodiments, the anti-wetting coating solution may be prepared at room temperature (about 20° C. t o about 28° C.) using conventional methods known in the art e.g., agitation, to form a homogenous solution. In some embodiments, the solvent used for the anti-wetting coating solution may comprise an alcohol, ketone, acetates, hydrocarbon, or fluorinated solvents, or a combination thereof. In some embodiments, the solvent may be a fluorinated solvent and may comprise chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof. In some embodiments, the fluorinated solvent may be an ethoxy-nanoafluorobutane (C₄F₉OC₂H₅) such as that marketed under the brand name Novec™ 7200 (obtained from 3M). In some embodiments, the fluorinated solvent may be an ethyl nonafluorosbutyl ether (C₅H₅F₅O) such as that marketed under the brand name BestSolv™ 7200 (obtained from Bestsolv).

In some embodiments the solvent may comprise an alcohol, ketone, acetates, hydrocarbon, such as ethyl alcohol, propyl alcohol, isopropanol, acetone, methyl ethyl ketone, ethyl acetate, butyl acetate, hexane, octane, decane, tetrahydrofuran, or mixtures thereof. In some embodiments, alcohols that may be used as a solvent may comprise but are not limited to methanol, ethanol, propanol, isopropanol, or a combination thereof.

In some embodiments, the anti-wetting chemical used for the anti-wetting coating solution may comprise polydimethyl siloxane silicone fluid, perfluoropolyethers, or a combination thereof. In some embodiments the anti-wetting chemical is a dialcohol terminated, exthoxylated perfluoropolyether such as that marketed under the brand name Fluorolink® E10-H. In some embodiments, the anti-wetting chemical may be present in the anti-wetting coating solution in an amount ranging from about 1 wt % to about 25 wt %, about 1 wt % to about 5 wt %, about 5 wt % to about 10 wt %, about 10 wt % to about 15 wt %, about 15 wt % to about 20 wt %, or about 20 wt % to about 25 wt %, based on the total weight of the anti-wetting coating solution.

The process proceeds to block 702, where the anti-wetting coating solution may be deposited onto a transfer medium, and a coating of the anti-wetting coating solution may be applied on the printhead cap seal member. In some embodiments, the anti-wetting coating solution may be deposited onto the transfer medium using methods commonly known in the art, such as but not including dipping the transfer medium in the anti-wetting coating solution, pouring the anti-wetting coating solution on the transfer medium, or spraying the anti-wetting coating solution on the transfer medium. In some embodiments, the transfer medium may comprise a brush, rag, or foam. After depositing the anti-wetting coating solution onto the transfer medium, the process proceeds to block 703 where the printhead cap seal member is coated with the anti-wetting coating solution by applying the anti-wetting coating solution deposited medium over the surface of the printhead cap seal member.

In some embodiments, after preparing the anti-wetting coating solution in block 701, the process may proceed directly to block 704 where the printhead cap seal member may be coated with the anti-wetting coating solution by spraying the anti-wetting coating solution or by submerging the printhead cap seal member directly in the anti-wetting coating solution. In some embodiments, the anti-wetting coating solution may be applied to the printhead cap seal member in an amount sufficient to prevent the adhesion and spreading of water on the surface of the printhead cap seal member. In some embodiments, the anti-wetting coating solution may be applied to the printhead cap seal member in an amount ranging from about 0.05 ml/cm² to about 0.5 ml/cm², about 0.05 ml/cm² to about 0.1 ml/cm², about 0.1 ml/cm² to about 0.2 ml/cm², about 0.2 ml/cm² to about 0.3 ml/cm², about 0.3 ml/cm² to about 0.4 ml/cm², or about 0.4 ml/cm² to about 0.5 ml/cm².

After coating the printhead cap seal member with the anti-wetting coating solution in blocks 702 and 703 or in block 704, the process proceeds to block 705 where the coated or treated printhead cap seal member is dried in air. In some embodiments, the drying process may be from about 1 minute to about 15 minutes, about 1 minute to about 5 minutes, about 5 minutes to about 10 minutes, or about 10 minutes to about 15 minutes in an ambient, room temperature environment. After drying, the cap assembly comprising the coated printhead cap seal member may be installed in an ink printer.

In some embodiments, as described in block 706, the coating process may be repeated after a threshold period of time, such as about every week, every two weeks, about every three weeks, or about every four weeks. In some embodiments, a threshold period may be a time period for the coated printhead cap seal member to exhibit a decrease in anti-wetting properties due to degradation of the anti-wetting coating on the printhead cap seal member. The threshold period of time may vary depending on the frequency of printer use, the number of purge and cleaning cycles, or the concentration or formulation of the anti-wetting coating solution used.

In some embodiments, the anti-wetting coating solution may optionally be applied to printhead faceplate 101 (as shown in FIG. 2) to prevent any adhesion or aggregation of water, ink droplets, or residual cleaning fluid on or near nozzle 104 of printhead assembly 100 using the same method as described above.

Additional advantages of the disclosed technology will become readily apparent to those skilled in the art from the following detailed description, wherein only some embodiments are shown and described. As will be realized, the disclosed technology is capable of other and different embodiments, and its details are capable of modifications in various obvious respects, all without departing from the disclosed technology. Accordingly, the examples and descriptions are to be regarded as illustrative in nature and not as restrictive.

### EXAMPLES

The methods presented in this document are next described by means of the following example. The use of these and other examples anywhere in the specification is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification and can be made without departing from its spirit and scope. The invention is therefore to be limited only by the terms of the claims, along with the full scope of equivalents to which the claims are entitled.

### Example 1: Preparation and Application of Anti-Wetting Coating Solution on the Printhead Cap Seal Member

An anti-wetting coating solution was prepared by diluting a dialcohol terminated, exthoxylated perfluoropolyether (e.g., Fluorolink® E10-H) in ethoxy-nanoafluorobutane (C₄F₉OC₂H₂) solvent (under brand name Novec 7200™) to arrive at about 25 wt % a dialcohol terminated, exthoxylated perfluoropolyether solution, based on the total weight of the anti-wetting coating solution. The anti-wetting coating solution was then applied to the printhead cap seal member of the cap assembly by applying the anti-wetting coating solution to a foam tip applicator and running the applicator along the surface of the printhead cap seal member of the cap assembly to form a thin layer of anti-wetting coating solution on the surface of the printhead cap seal member. For a printhead cap seal member having a total contact or surface area of about 50 cm², about 2 ml of the anti-wetting coating solution was used to fully coat the surface of the printhead cap seal member. The treated printhead cap seal member was then air-dried in an ambient condition 25° C. at 50% humidity) for 5 minutes.

### Example 2: Anti-Wetting Properties of Treated Printhead Cap Seal Member

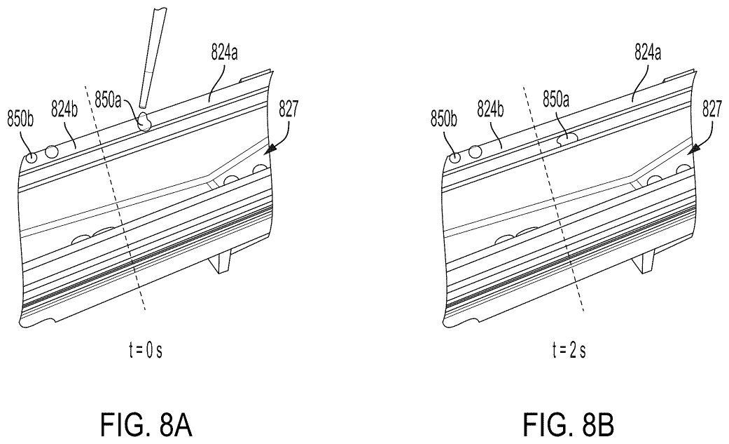

In this example, the treated/coated printhead cap seal member was tested to evaluate the anti-wetting properties compared to the untreated/uncoated printhead cap seal member. As seen in FIG. 8A, a section of printhead cap seal member 824a (region right of the dotted line) was coated with the anti-wetting solution of Example 1 while a second section of printhead cap seal member 824b (region left of the dotted line) was left uncoated. Afterward, water droplet 850a (about 150 microliters) and water droplet 850b (about 150 microliters) were applied to coated printhead cap seal member 824a and uncoated printhead cap seal member 824b respectively. As seen in FIG. 8B, two seconds (t=2 s) after water droplet application, it was observed that water droplet 850a applied on the coated section of printhead cap seal member 824a did not adhere to and the droplets slid down the slope of coated printhead cap seal member 824a and eventually into tray 827 for accumulation and removal of the droplets. Comparatively, water droplet 850b placed on the uncoated section of printhead cap seal member 824b continued to stick to and aggregate on the printhead cap seal member. The coated printhead cap seal member 824a exhibited high anti-wetting properties for at least two weeks. Upon decrease in the anti-wetting properties, i.e., water droplets started to stick and accumulate on the printhead cap seal member, the printhead cap seal member was recoated using the same method described above.

Overall, the disclosed method of coating the printhead cap seal member of the cap assembly achieved effective water-repelling, and anti-wetting properties without the use of toxic or chemically reactive cleaning fluid formulations or other movable mechanical parts. This passive approach not only improves the print quality through the effective removal of clogged ink and contaminants from print nozzles or jets, but also prevents damages to the printhead from residual water present on the cap assembly, thereby extending the lifecycle of the printers. The disclosed method may be easily performed by a technician or a customer without the disassembly of the cap assembly, and the cap assembly is easily user-replaceable.

The features and functions described above, as well as alternatives, may be combined into many other different systems or applications. Various alternatives, modifications, variations or improvements may be made by those skilled in the art, each of which is also intended to be encompassed by the disclosed embodiments.

1. A printhead cap assembly, comprising:
a housing configured to receive a printhead, the housing comprising sidewalls, a bottom wall, and a top aperture forming a tray; and
a cap seal member disposed on edges around the top aperture, wherein:
the cap seal member comprises a first surface configured to engage with and form a seal around the surface of the printhead when the printhead is docked in the housing;
the first surface is coated with an anti-wetting solution, and
in an undocked configuration, the cap seal member is configured to receive residual fluid from the printhead and direct the residual fluid into the tray.

2. The cap assembly of claim 1, wherein the first surface is sloped inwards towards the tray at an angle from about 45° to about 75°.

3. The cap assembly of claim 1, wherein the coated first surface comprises:
a water contact angle from about 90° to about 120° or a water sliding angle from about 10° to about 20°.

4. The cap assembly of claim 1, wherein the anti-wetting solution comprises:
a solvent; and
an anti-wetting chemical;
wherein the anti-wetting chemical comprises polydimethyl siloxane silicone fluid, perfluoropolyethers, or a combination thereof.

5. The cap assembly of claim 4, wherein the solvent comprises an alcohol, ketone, acetates, hydrocarbon, fluorinated solvent, or a combination thereof.

6. The cap assembly of claim 4, wherein the solvent is a fluorinated solvent and comprises chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof.

7. The cap assembly of claim 4, wherein the anti-wetting chemical is present in the anti-wetting solution in an amount ranging from about 1 wt % to about 25 wt %, based on the total weight of the anti-wetting solution.

8. The cap assembly of claim 1, wherein the anti-wetting solution is coated on the first surface in an amount from about 0.05 ml/cm² to about 0.5 ml/cm².

9. The cap assembly of claim 1, wherein the coated first surface maintains anti-wetting properties for at least about 4 weeks.

10. An ink printer comprising the printhead cap assembly of claim 1.

11. A method for coating a printhead cap seal member with an anti-wetting coating, the method comprising:
preparing an anti-wetting coating solution comprising a solvent and an anti-wetting chemical;
coating the printhead cap seal member with the anti-wetting coating solution to produce a coated printhead cap seal member; and
drying the coated printhead cap seal member,
wherein the solvent comprises an alcohol, ketone, acetates, hydrocarbon, fluorinated solvent, or a combination thereof, and
wherein the anti-wetting chemical comprises a polydimethyl siloxane silicone fluid, perfluoropolyethers, or a combination thereof.

12. The method of claim 11, wherein the solvent is a fluorinated solvent and comprises chlorofluorocarbons (CFCs), hydrochlorofluorocarbons (HCFCs), hydrofluorocarbons (HFCs), hydrofluoroethers (HFEs), hydrofluoroolefins (HFOs), or a combination thereof.

13. The method of claim 11, wherein preparing the anti-wetting coating solution comprises adding the anti-wetting chemical in an amount ranging from about 1 wt % to about 25 wt %, based on the total weight of the anti-wetting coating solution.

14. The method of claim 11, wherein coating the printhead cap seal member with the anti-wetting coating solution provides surface of the printhead cap seal member with a water contact angle from about 90° to about 120° or a water sliding angle from about 10° to about 20°.

15. The method of claim 11, wherein coating the printhead cap seal member with the anti-wetting coating solution comprises depositing the anti-wetting coating solution onto a transfer medium, and using the transfer medium to apply the anti-wetting coating solution to the printhead cap seal member.

16. The method of claim 15, wherein the transfer medium comprises a brush, rag, or foam.

17. The method of claim 11, wherein coating the printhead cap seal member with the anti-wetting coating solution comprises spraying the anti-wetting coating solution on the printhead cap seal member or submerging the printhead cap seal member in the anti-wetting coating solution.

18. The method of claim 11, wherein coating the printhead cap seal member comprises coating from about 0.05 ml/cm² to about 0.5 ml/cm² of the anti-wetting coating solution to the printhead cap seal member.

19. The method of claim 11, wherein drying the coated printhead cap seal member comprises air drying the coated printhead cap seal member from about 1 minute to about 15 minutes.

20. The method of claim 11, further comprising recoating the printhead cap seal member with the anti-wetting coating solution after a threshold period of time.
